(19) United States
(12) Patent Application Publication
(10) Pub. No.: US 2012/0070811 A1
(43) Pub. Date: Mar. 22, 2012

(54) SYSTEMS AND METHODS FOR MEASURING AND MANIPULATING A RADIOLOGIST'S EXAM SENSITIVITY AND SPECIFICITY IN REAL TIME

(75) Inventors: Stephen Anthony Fox, Barrington, IL (US); Jason Danielson, Palatine, IL (US); Luke Iver Sandberg, Barrington, IL (US)

(73) Assignee: GENERAL ELECTRIC COMPANY, Schenectady, NY (US)

(21) Appl. No.: 12/888,198

(22) Filed: Sep. 22, 2010

(51) Int. Cl. G09B 23/28

(52) U.S. Cl. 434/262

(57) ABSTRACT

Certain examples provide systems and methods for radiologist performance review. A method includes receiving a series of images for review by a user at an exam reader, the series of images including both actual patient images for review and test images for evaluation of user performance. The method also includes capturing a user report including analysis of at least a portion of the series of images including at least one actual patient image and at least one test image. The method further includes evaluating performance of the user based on a comparison of the user's analysis of the at least one test image to a predetermined analysis of the at least one test image. Additionally, the method includes generating at least one metric regarding user performance based on the comparison to be output with respect to the user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Examining a patient can be logistically complex and involve many steps. Using a radiological procedure as an example, following his or her initial examination, a patient schedules an appointment for the radiological examination. Then, the patient travels to the department at the appointed time and date. Upon arrival at the radiology department the patient registers with the radiology staff and is prepared for the radiological examination, if necessary, such as by donning an examination gown. The patient may then have to wait until an examining room is available and then is examined. Following the examination, the radiograph or other imagery is examined by a radiologist. Finally, the radiologist prepares a report which is then sent to the referring physician.

The competence and efficiency with which each of these tasks is conducted affects the overall quality and efficiency of the radiology department. It also affects the patient's and referring physician's satisfaction with the services performed. Thus, to the extent that efficiency and satisfaction could be improved, the operation of the department, including such things as quality and profitability, could also likely be improved. Yet, scientific and other structured methodologies have not, in general, been applied to study and improve the operations of a radiology department or, for that matter, other procedures that are carried out on a relatively frequent basis in the departments of a healthcare facility.

### BRIEF SUMMARY

Certain examples provide systems and methods for radiologist performance review.

Certain examples provide an exam reading and evaluation system. The system includes an exam reader to allow a user to review, analyze, and report on content related to a medical exam. The exam reader is to display a series of images including at least one actual patient image from the medical exam and at least one test image for user review and analysis. The system also includes an evaluator component to evaluate performance of the user based on a comparison of the user's analysis of the at least one test image to a predetermined analysis of the at least one test image. The evaluator component is to generate at least one metric regarding user performance to be output with respect to the user.

Certain examples provide a tangible computer readable storage medium including a set of instructions which, when executed using a processor, implement an exam reading and evaluation system. The system includes an exam reader to allow a user to review, analyze, and report on content related to a medical exam. The exam reader is to display a series of images including at least one actual patient image from the medical exam and at least one test image for user review and analysis. The system also includes an evaluator component to evaluate performance of the user based on a comparison of the user's analysis of the at least one test image to a predetermined analysis of the at least one test image. The evaluator component is to generate at least one metric regarding user performance to be output with respect to the user.

Certain examples provide a computer-implemented method for exam reading and evaluation. The method includes receiving a series of images for review by a user at an exam reader, the series of images including both actual patient images for review and test images for evaluation of user performance. The method also includes capturing a user report including analysis of at least a portion of the series of images including at least one actual patient image and at least one test image. The method further includes evaluating performance of the user based on a comparison of the user's analysis of the at least one test image to a predetermined analysis of the at least one test image. Additionally, the method includes generating at least one metric regarding user performance based on the comparison to be output with respect to the user.

### BRIEF DESCRIPTION OF SEVERAL VIEWS OF THE DRAWINGS

FIG. 1 illustrates an example radiological examination procedure resulting in the generation of a radiological report.

FIG. 2 illustrates an example image reading and reporting system.

FIG. 3 illustrates an example image reading and reporting system.

FIG. 4 illustrates an example image reading and reporting workflow.

FIG. 5 is a block diagram of an example processor system that may be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide tracking and analysis of image reading/review. With an increasing reliance on imaging to support medical diagnoses it is important for clinicians to fully understand the limitations of their imaging reports. Thus, imaging should be treated as any other medical test, by tracking is Sensitivity and Specificity metrics. These two metrics can help providers to understand the values of the medical test. Unfortunately, while some studies have produced broad averages of these metrics for certain types of exam studies, there can be great variation between any two given radiologists.

Certain examples provide systems and methods to track, in real time or substantially real time given a system delay (e.g., processing, memory access, transmission, etc.), a given radiologist's performance metric (e.g., sensitivity and specificity) for different exam types. Performance metric(s) can be generated, for example, by injecting exams with known diagnoses into a radiologist's work list. Radiologists would be unaware of which exams were real and which were created by the testing system. By comparing the radiologists' diagnoses with the known results, “real time” estimates of performance metrics (e.g., their Sensitivity and Specificity) can be provided. Knowing these metrics, information can be used to detect possible biases in the radiologist and correct/account for them.

When a radiologist is going through his or her work list, it is common for the radiologist to focus on a particular exam type (e.g. mammograms) for extended periods of time. In certain examples, this event can be monitored and observed to trigger an insertion or injection exams of that type with known results into the radiologist's work list. When the radiologist reviews this “test” exam, he/she will be unaware that it has a known result. After the radiologist has finished reading the exam, the radiologist's final diagnosis can be compared with the known results to evaluate if the radiologist has produced a true positive, a false positive, a true negative, or a false negative. Once enough of this data has been accumulated, a running estimate of the radiologist's specificity and sensitivity with this exam type can be generated.

Once these metrics have been generated, possible biases that exist in the radiologist can be inferred and an attempt made to correct for them. For example, a common bias is an availability bias, where a radiologist would identify benign breast masses as malignant merely because he or she has seen a lot of malignant masses recently. In certain examples, a bias can be identified as a sudden increase in the false positive metric, and this can be corrected by increasing the number of negative exams that are injected into the work list.

Certain examples help to more accurately track radiologist performance on exam types in real time (or substantially real time including a system delay). Certain examples help reviewers (e.g., hospital administrators, department managers, human resources, etc.) understand various cognitive bias(es) that the radiologist might be experiencing and then correct for them by modifying the exam mix for the radiologist.

With a focus on quality (e.g., pay for performance), there is an increased demand from customers to be able to measure and track performance. By helping to track and improve radiologist performance, hospital performance and ratings can be positively impacted by such improved radiologist performance.

Sensitivity and specificity are statistical measures of the performance of a binary classification test by a user (e.g., a radiologist and/or other clinician). Sensitivity (also referred to as recall rate) measures a proportion of actual positives that are correctly identified as such (e.g., a percentage of sick people who are correctly identified as having a condition). Specificity measures a proportion of negatives that are correctly identified (e.g., a percentage of healthy people who are correctly identified as not having the condition). A theoretical, optimal prediction can achieve 100% sensitivity (e.g., predict all people from the sick group as sick) and 100% specificity (e.g., not predict anyone from the healthy group as sick).

For example, a radiologist reviews a series of images in a study to identify an abnormality in a number of patients. Each person imaged either has or does not have the abnormality, which may indicate a disease. The image reading outcome can be positive (indicating that the person has the abnormality) or negative (indicating that the person does not have the abnormality). Image reading results for each subject may or may not match the subject's actual status. In this example, a true positive corresponds to sick people correctly diagnosed as sick. A false positive corresponds to healthy people incorrectly identified as sick. A true negative corresponds to healthy people correctly identified as healthy. A false negative corresponds to sick people incorrectly identified as healthy.

A specificity of 100% means that the test recognizes all actual negatives; for example, all healthy people will be recognized as healthy. Because 100% specificity means no negatives are incorrectly tagged as positive, a positive result in a high specificity test is used to confirm the disease. The maximum can trivially be achieved by a test that always reports negative; for example, a test claims that everybody is healthy regardless of the true condition. Therefore, the specificity alone does not indicate how well the test recognizes positive cases. The sensitivity of the test should also be determined

A sensitivity of 100% means that the test recognizes all actual positives; for example, all sick people are recognized as being ill. Thus, in contrast to a high specificity test, negative results in a high sensitivity test are used to rule out the disease. Sensitivity alone does not indicate how well the test predicts other classes (that is, about the negative cases). In binary classification, as illustrated above, this is indicated by a corresponding specificity test.

For example, a medical diagnostic criterion can be described as having a sensitivity of 40% and a specificity of 90%. The sensitivity and specificity indicates that only 40% of people with the disease will satisfy the criterion, and 90% of people without the disease will not satisfy the criterion. Thus, “specific” tests help confirm a diagnosis while “sensitive” tests help exclude a diagnosis.

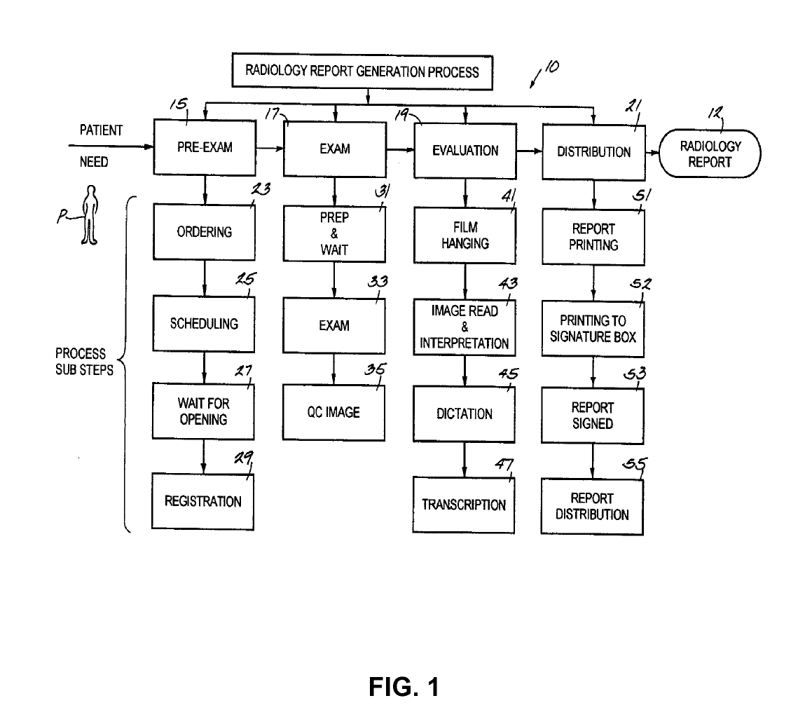

FIG. 1 schematically illustrates an example radiological examination procedure 10 resulting in the generation of a radiological report 12. As noted above, once a determination is made that a patient should have a radiological procedure, the patient (represented by the patient P) interacts with a radiology department with the final result of producing a radiological report. The procedure 10 may be conceptualized as having four major steps, blocks, or components: pre-examination 15, main examination 17, evaluation 19, and distribution 21. The pre-examination 15 involves several sub-blocks: ordering the radiological procedure 23, scheduling the procedure 25, waiting for the examination 27, and registration 29. Once ordered and scheduled, the actual examination or procedure is conducted. The main examination 17 includes a period of patient preparation and waiting 31, an actual examination period 33, and quality control review 35 of the image made during the examination. Once an image of sufficient quality has been produced, it must be evaluated by a radiologist. The evaluation 19 involves image hanging or display 41 and review and interpretation 43 of the image. Generally, as the radiologist reviews the image he or she dictates an oral report on the results of the radiological procedure as represented by a dictation 45. The final piece in evaluation of the examination is a transcription 47 where the dictated report is transcribed to a form that may be printed.

Once the report is transcribed, it is distributed. The distribution 21 involves a report printing 51, a printing to signature box 52 during which the printed report is transferred to a signature box, a signing of the report 53, and an actual distribution of the report 55, where the report is sent to the referring physician, the patient, or both.

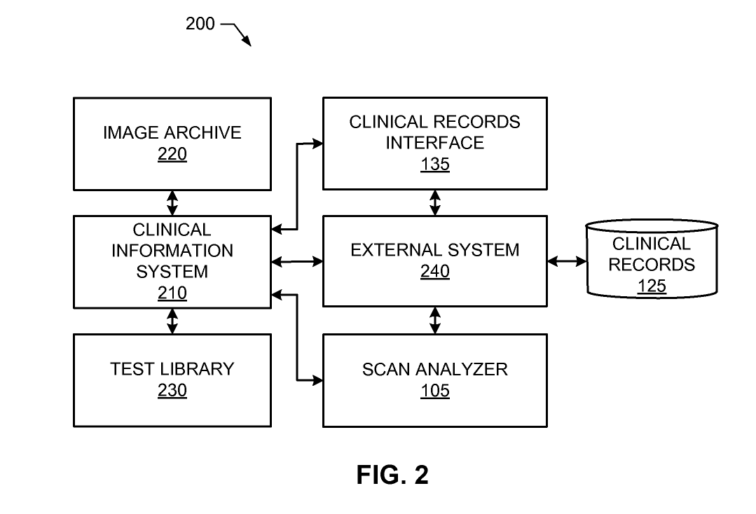

FIG. 2 illustrates an example image reading and reporting system 200 including a clinical information system 210 (such as a radiology information system (RIS) and/or a picture archiving and communication system (PACS)), an image archive 220, a test library 230, and an external system 240. The information system 210 allows a user, such as a radiologist or other clinician, to retrieve images, review those images, and generate report(s) and/or other output regarding image(s) reviewed.

The information system 210 receives exam image(s) from the image archive 220 for review by a user. The image(s) can be retrieved on command by a user, prefetched according to an order and/or user preference, etc. The information system 210 can also receive test image(s) from the test library 230. For example, according to external operator prompt, automated program, and/or other stimulus, test image(s) can be mixed with actual exam image(s) for user review at the information system 210.

A user, such as a radiologist and/or other clinician, reviews the retrieved images at the information system 210 and generates a report and/or other analysis of the images. For example, the user may annotate findings in one or more images and document those findings in a report to a surgeon, primary physician, specialist, and/or other clinician associated with the patient in the image(s). If test image(s) are included in the series provided to the user at the information system 210, then the report includes findings and/or other analysis of the test image(s) as well as the actual exam image(s).

Results can be provided (e.g., via a push and/or pull) to the external system 240. The external system 240 looks for test image(s) within the review results and compares the user's evaluation of the test image(s) with the known or predetermined evaluation of the test image(s). Based on this comparison, a metric or score for the user can be determined For example, the user can be evaluated to determine his or her accuracy. A comparison can determine whether the user is generating too many false negatives and/or false positives. If it is determined that the radiologist is providing too many false negatives, for example, the external system 240 can trigger the input of more positive test images from the test library 230 to the information system 210 to help correct any bias the user may be developing and to further train the user.

One or more metrics, such as sensitivity and specificity metrics, can be applied to the results generated by a user at the information system 210. These metrics can trigger a change in the mix of exams provided to a user, for example. Metrics can be used for performance tracking, for example. Metrics can be used to drive a certain workflow of exams to certain users (e.g., radiologists). In certain examples, an aggregated rating can be generated as well as providing breakdowns for certain types of tests and reading (e.g., statistics for mammograms, etc.). Such breakdowns can be used to assign radiologists to certain exams (e.g., based on modality, diagnostic question, etc.).

In another example, rather than having an external system 240, monitoring and evaluation can occur within the information system 210 (e.g., a RIS and/or PACS). As an integrated feature, for example, as soon as the radiologist completes a report on an image, the report can be evaluated (e.g., by software) and compared to the expected result. In certain examples, a “real-time” monitor is provided to track time spent, number of changes/corrections, etc., for a user. Using the predetermined or “known” results, “real time” comparison and tracking is enabled for radiologist performance as part of the radiologist's workflow without his or her knowledge or extra involvement.

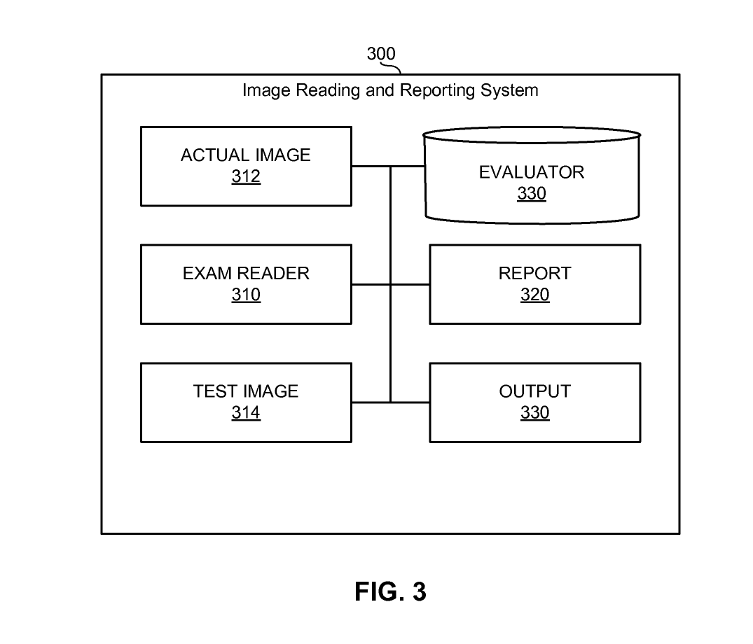

FIG. 3 illustrates an example image reading and reporting system 300 including an exam reader 310, an actual image for review 312, a test image for review 314, a report 320, an evaluator 330, and an output 340. The exam reader 310 receives images for review by a user. The images can be retrieved on command by a user, prefetched according to an order and/or user preference, etc. The images include an actual image for review 312 and a test image for review 314. For example, according to external operator prompt, automated program, and/or other stimulus, test image(s) 314 can be mixed with actual exam image(s) 312 for user review at the exam reader 310.

A user, such as a radiologist and/or other clinician, reviews the retrieved images at the exam reader 310 and generates a report 320 and/or other analysis of the images. For example, the user can annotate findings in one or more images and document those findings in a report to a surgeon, primary physician, specialist, and/or other clinician associated with the patient in the image(s). If test image(s) 314 are included in the series provided to the user at the exam reader 310, then the report 320 includes findings and/or other analysis of the test image(s) 314 as well as the actual exam image(s) 312. The report 320 can be output 340 for storage, relay to another clinician, provision to a patient, etc.

Results can be provided (e.g., via a push and/or pull) to the evaluator 330. The evaluator 330 looks for test image(s) 314 within the review results and compares the user's evaluation of the test image(s) 314 with the known or predetermined evaluation of the test image(s) 314. Based on this comparison, a metric or score for the user can be determined For example, the user can be evaluated to determine his or her accuracy. A comparison can determine whether the user is generating too many false negatives and/or false positives. If it is determined that the radiologist is providing too many false negatives, for example, the evaluator 330 can trigger the input of more positive test images 314 to the exam reader 310 to help correct any bias the user may be developing and to further train the user.

One or more metrics, such as sensitivity and specificity metrics, can be applied to the results generated by a user at the exam reader 310. These metrics can trigger a change in the mix of exams provided to a user, for example. Metrics can be used for performance tracking, for example. Metrics can be used to drive a certain workflow of exams to certain users (e.g., radiologists). In certain examples, an aggregated rating can be generated as well as providing breakdowns for certain types of tests and reading (e.g., statistics for mammograms, etc.). Such breakdowns can be used to assign radiologists to certain exams (e.g., based on modality, diagnostic question, etc.).

In another example, rather than having a distinct evaluator 330, monitoring and evaluation can occur within the exam reader 310 (e.g., a RIS and/or PACS). As an integrated feature, for example, as soon as the radiologist completes a report on an image, the report can be evaluated (e.g., by software) and compared to the expected result. In certain examples, a “real-time” monitor is provided to track time spent, number of changes/corrections, etc., for a user. Using the predetermined or “known” results, “real time” comparison and tracking is enabled for radiologist performance as part of the radiologist's workflow without his or her knowledge or extra involvement.

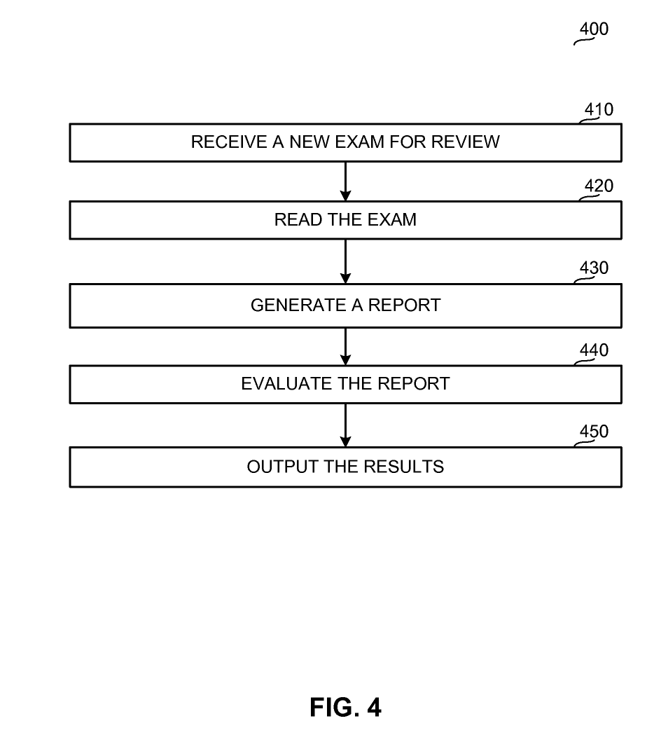

FIG. 4 illustrates an example image reading and reporting workflow 400 including receiving a new exam 410, reading an exam 420, generating a report 430, evaluating the report 440, and output 450.

FIG. 4 is a flow diagram representative of example machine readable instructions that may be executed to implement the example systems 100, 200, 300 of FIGS. 1, 2, and 3 and/or portions of one or more of those systems. The example processes of FIG. 4 may be performed using a processor, a controller and/or any other suitable processing device. For example, the example processes of FIG. 4 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 4 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 may be implemented manually or as any combination(s) of any of the foregoing techniques, for example, any combination of firmware, software, discrete logic and/or hardware. Further, although the example processes of FIG. 4 are described with reference to the flow diagrams of FIG. 4, other methods of implementing the processes of FIG. 4 may be employed. For example, the order of execution of the blocks may be changed, and/or some of the blocks described may be changed, eliminated, sub-divided, or combined. Additionally, any or all of the example processes of FIG. 4 may be performed sequentially and/or in parallel by, for example, separate processing threads, processors, devices, discrete logic, circuits, etc.

At 410, a user (e.g., a radiologist) receives a new exam for review. The images can be retrieved on command by a user, prefetched according to an order and/or user preference, etc. The images include one or more actual images for review and one or more test images for review. For example, according to external operator prompt, automated program, and/or other stimulus, test image(s) are mixed with actual exam image(s) for user review.

At 420, a user, such as a radiologist and/or other clinician, reviews the retrieved images and, at 430, generates a report and/or other analysis of the images. For example, the user can annotate findings in one or more images and document those findings in a report to a surgeon, primary physician, specialist, and/or other clinician associated with the patient in the image(s). If test image(s) are included in the series provided to the user, then the report includes findings and/or other analysis of the test image(s) as well as the actual exam image(s).

At 440, the user's report results are evaluated. For example, the user's analysis of test image(s) is identified within the review results and compared with the known or predetermined evaluation of the test image(s). Based on this comparison, a metric or score for the user can be determined For example, the user can be evaluated to determine his or her accuracy. A comparison can determine whether the user is generating too many false negatives and/or false positives. If it is determined that the radiologist is providing too many false negatives, for example, more positive test images can be provided for user review to help train the user and correct a bias the user may be developing.

Metrics can be used for performance tracking, for example. Metrics can be used to drive a certain workflow of exams to certain users (e.g., radiologists). In certain examples, an aggregated rating can be generated as well as providing breakdowns for certain types of tests and reading (e.g., statistics for mammograms, etc.). Such breakdowns can be used to assign radiologists to certain exams (e.g., based on modality, diagnostic question, etc.). In certain examples, a “real-time” monitor is provided to track time spent, number of changes/corrections, etc., for a user. Using the predetermined or “known” results, “real time” comparison and tracking is enabled for radiologist performance as part of the radiologist's workflow without his or her knowledge or extra involvement.

At 450, the user's report on the images can be output for storage, relay to another clinician, providing to a patient, etc.

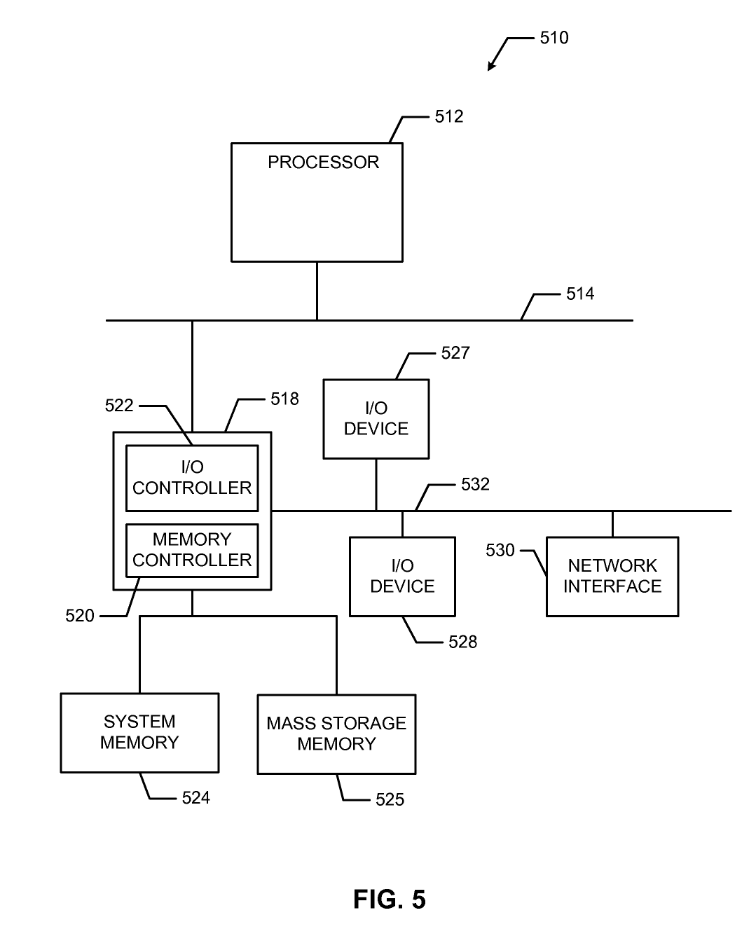

FIG. 5 is a block diagram of an example processor system 510 that may be used to implement the systems, apparatus and methods described herein. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Thus, certain embodiments provide.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An exam reading and evaluation system, said system comprising:
an exam reader to allow a user to review, analyze, and report on content related to a medical exam, wherein the exam reader is to display a series of images including at least one actual patient image from the medical exam and at least one test image for user review and analysis;
an evaluator component to evaluate performance of the user based on a comparison of the user's analysis of the at least one test image to a predetermined analysis of the at least one test image, wherein the evaluator component is to generate at least one metric regarding user performance to be output with respect to the user.

2. The system of claim 1, wherein the at least one metric comprises at least one of a specificity metric and a sensitivity metric.

3. The system of claim 2, wherein the at least one metric comprises a specificity metric and a sensitivity metric.

4. The system of claim 1, wherein the at least one metric is to be used to adjust a mix of images sent to the user for review.

5. The system of claim 4, wherein the at least one metric is to be used to provide at least one of a) an increased number of positive test images if the at least one metric indicates the user has a number of false negatives greater than a threshold and b) an increased number of negative test images if the at least one metric indicates the user has a number of false positives greater than a threshold.

6. The system of claim 1, wherein said at least one metric comprises an aggregated rating and at least one rating for a particular type of test exam reading.

7. The system of claim 6, wherein the at least one rating for a particular type of test exam reading is to be used to assign the user to review an exam.

8. The system of claim 1, wherein the exam reader and the evaluator are incorporated within at least one of a picture archiving and communication system and a radiology information system.

9. A tangible computer readable storage medium including a set of instructions which, when executed using a processor, implement an exam reading and evaluation system, said system comprising:
an exam reader to allow a user to review, analyze, and report on content related to a medical exam, wherein the exam reader is to display a series of images including at least one actual patient image from the medical exam and at least one test image for user review and analysis;
an evaluator component to evaluate performance of the user based on a comparison of the user's analysis of the at least one test image to a predetermined analysis of the at least one test image, wherein the evaluator component is to generate at least one metric regarding user performance to be output with respect to the user.

10. The system of claim 1, wherein the at least one metric comprises at least one of a specificity metric and a sensitivity metric.

11. The system of claim 2, wherein the at least one metric comprises a specificity metric and a sensitivity metric.

12. The system of claim 1, wherein the at least one metric is to be used to adjust a mix of images sent to the user for review.

13. The system of claim 4, wherein the at least one metric is to be used to provide at least one of a) an increased number of positive test images if the at least one metric indicates the user has a number of false negatives greater than a threshold and b) an increased number of negative test images if the at least one metric indicates the user has a number of false positives greater than a threshold.

14. The system of claim 1, wherein said at least one metric comprises an aggregated rating and at least one rating for a particular type of test exam reading.

15. The system of claim 6, wherein the at least one rating for a particular type of test exam reading is to be used to assign the user to review an exam.

16. The system of claim 1, wherein the exam reader and the evaluator are incorporated within at least one of a picture archiving and communication system and a radiology information system.

17. A computer-implemented method for exam reading and evaluation, said method comprising:
receiving a series of images for review by a user at an exam reader, the series of images including both actual patient images for review and test images for evaluation of user performance;
capturing a user report including analysis of at least a portion of the series of images including at least one actual patient image and at least one test image;
evaluating performance of the user based on a comparison of the user's analysis of the at least one test image to a predetermined analysis of the at least one test image; and
generating at least one metric regarding user performance based on the comparison to be output with respect to the user.

18. The method of claim 17, wherein the at least one metric comprises at least one of a specificity metric and a sensitivity metric.

19. The method of claim 17, wherein said at least one metric comprises at least one rating for a particular type of test exam reading to be used to assign the user to review an exam.

20. The method of claim 17, wherein the exam reader and the evaluator are incorporated within at least one of a picture archiving and communication system and a radiology information system.
